(19) United States
(12) Patent Application Publication
(10) Pub. No.: US 2005/0086879 A1
(43) Pub. Date: Apr. 28, 2005

(54) Retainer for prehung door

(76) Inventor: Charles R. Sales, West Linn, OR (US)

Correspondence Address: SCHWABE, WILLIAMSON & WYATT, P.C.;PACWEST CENTER, SUITES 1600-1900, 1211 SW FIFTH AVENUE, PORTLAND, OR, 97204, US

(21) Appl. No.: 10/693,570

(22) Filed: Oct. 24, 2003

(51) Int. Cl. E06B 1/04

(52) U.S. Cl. 52/204.1

(57) ABSTRACT

A retainer for a patio door wherein a door closes against a metal mullion. The metal mullion has an edge in face-to-face adjacency with a distal edge end of the door. A slot in the mullion edge is fitted with clips that secure a striker plate to the mullion. The striker plate has an opening for receiving a latch. The door is prepped to receive a handle and latch mechanism, including an edge bore aligned with the opening of said striker plate. The retainer includes a plug slidable into the edge bore and having a protrudable end that is slidable from the edge bore and into engagement with the opening of said striker plate. Preferably a keeper applied to the plug locks the plug in the protruded position.

### FIELD OF INVENTION

This invention relates to a retainer for a prehung door and more particularly to a type of door referred to herein as a patio door.

### BACKGROUND OF THE INVENTION

The term “prehung door” historically has applied to wood doors prehung in wood frames wherein one side edge is secured to the frame by hinges and the opposing side edge is pivotal and designed to be secured to the frame by a releasable latch mechanism. A category of doors not typically considered a prehung door is here referred to as patio door. A patio door typically is understood to have a fixed window portion and a sliding window or door portion, the latter supported in a slideway and which slides in one direction to an overlapping relation with the fixed window portion to expose a door opening, and slidable in the opposite direction to close the door opening. The fixed and slidable window/door portions are commonly supported in a metal frame.

A change that has occurred in patio doors is the conversion of the sliding type patio doors to a pivoting type patio door more typical of the above described “prehung doors.” Such doors are referred to as a “hinged patio door” and are designed to provide a similar patio door appearance but with a swinging door opening and closing against a metal frame or mullion which supports an adjacent window portion as typical for patio doors as described above. Such hinged patio doors are preconstructed, i.e., installed into its metal frame at a factory site and shipped to a construction site for assembly into a building wall. The doors are not provided with the door mounted latch mechanism, e.g., handle and slide latch which presents a shipping problem. The door is desirably secured in position in the door frame during shipment to prevent damage, but prior to this invention, securement devices for such doors were considered unsatisfactory. Attempts have been made to use different kinds of temporary, i.e., removable fasteners, but such have consisted of screws and straps and the like that are difficult to install and risk marring a portion of the frame or door that may be observable following assembly into a building.

Retainers such as described in commonly owned U.S. Pat. Nos. 5,159,782 and 5,562,315 (the disclosures of which are incorporated herein by reference) were not applicable to this use as such retainers were designed to fit into a standard bore provided in the wood door jamb for the latch mechanism and which served as a receiving bore for the retainer. The striker plate portion of the latch mechanism for such prehung doors and which fits over the above standard bore is mounted to the doorjamb following delivery of the door assembly to the building site and removal of the retainer. The metal mullions of the herein “hinged patio door” is provided with an elongate slot and the striker plates are mounted along the slots via mounting tabs secured to the slot edges. The slot replaces the above standard bore and will not accommodate the retainers of the above patents.

### BRIEF DESCRIPTION OF THE INVENTION

The present invention involves first an appreciation that the mounting or locking tabs for mounting the striker plates to the mullions are desirably preset into the mullions at the factory to ensure a proper fit of the corresponding latch mechanism for the door; and such preset can be accomplished by applying the striker plates to the mullion at the factory. With the striker plates in place, there is a commonly sized latch receiving opening that is aligned with the latch receiving bores in the door. As before, the handle or knob and latch portion of the latch mechanism is nevertheless applied to the door at the building site. A retainer is thus designed to fit the “prepped” door bores and the latch receiving opening of the installed striker plate. A plug portion of the retainer is inserted through the door edge bore. With the protrudable end portion of the plug seated fully in the door edge bore, the prehung door is closed which aligns the protrudable end portion with the latch receiving opening of the striker plate. The protrudable end portion is then slid out of the edge bore and into the latch receiving opening. A cross slot in the protrudable end portion is exposed between the mullion and door edge, and a retention tab is inserted to secure the plug and thereby lock the door in the closed position, i.e., for shipping.

The invention will be more fully appreciated and understood upon reference to the following detailed description and the drawings referred to therein.

### DESCRIPTION OF THE DRAWINGS

FIG. 1 is an exploded view illustrating the manner of securing striker plates to a metal mullion as used in constructing a hinged patio door to which the invention is applied;

FIG. 2 is an illustration of a factory assembled hinged patio door ready for shipment and in accordance with the assembly of FIG. 1;

FIG. 3 is a section view as taken on view lines 3-3 of FIG. 2;

FIG. 4 is a section view as taken on view lines 4-4 of FIG. 3;

FIG. 5 is a side view of the plug portion of a retainer of the invention as seen in FIGS. 3 and 4; and

FIG. 6 is a perspective view of a keeper portion for the retainer as seen in FIGS. 3 and 4.

### DETAILED DESCRIPTION OF A PREFERRED EMBODIMENT

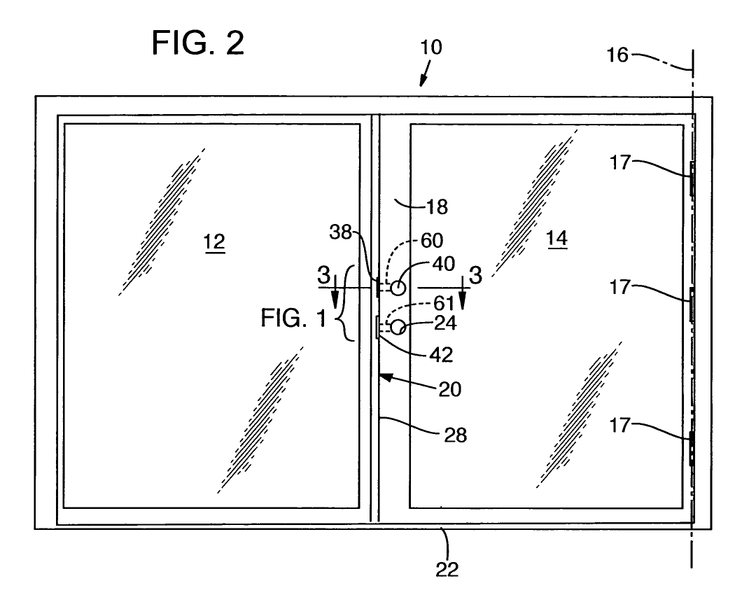

FIG. 2 illustrates a hinged patio door as that term is herein intended which encompasses a two-part door-window arrangement 10, including a window portion 12 and a door portion 14. The door portion pivots about an axis 16 defined by hinges 17 whereby the distal end 18 of the door pivots about axis 16 to swing away from and toward mullion 20, the mullion being affixed to a frame 22 that surrounds and is part of the door-window arrangement 10.

The door-window arrangement 10, as shown in FIG. 2, is not installed in a wall of a building but instead is shown in a ready condition for shipment from the manufacturer to a building site. It includes a pair of circular openings 24, 40, one for a spring lock and the other for a deadbolt lock, but either of which might be provided without the other. The openings 24, 40 are sized to receive a door handle or door knob to be installed at the building site and is similarly without the latch mechanism, including a slidable latch associated with a handle and operated by turning of the handle for securing and alternatively releasing the door from its closed position against the mullion 20.

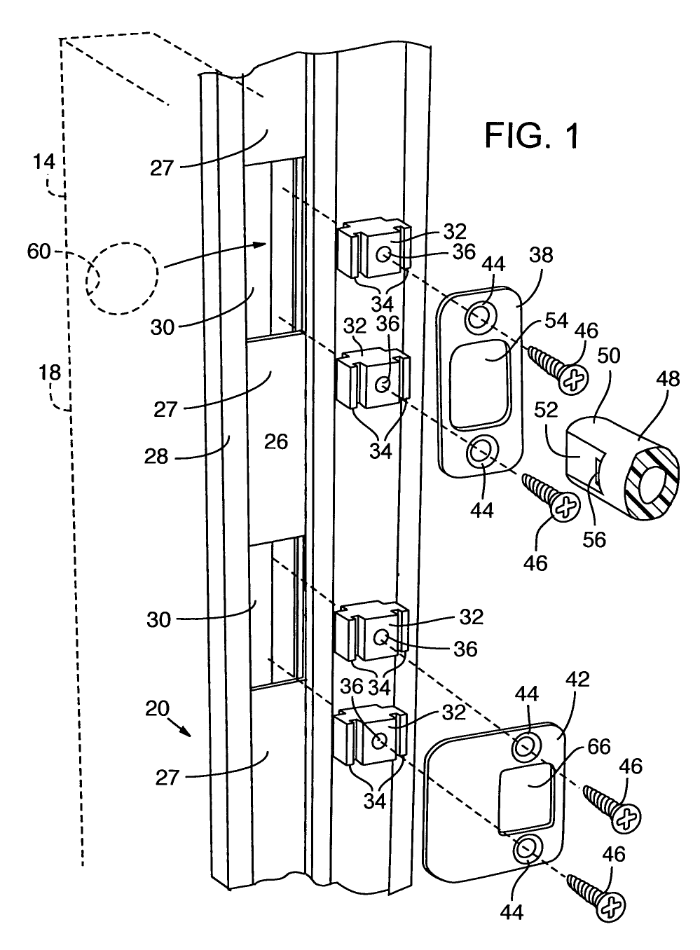

FIG. 1 illustrates a portion of the mullion 20 as generally viewed in FIG. 2. The mullion 20 is fabricated steel sheeting that is press formed to create side rails 26, 28, with an intermediate slot 30. Mounted between the rails and within the slot 30 are clip fasteners 32. A leg 34 at each side of the fastener 32 fits behind an edge of each of the rails 26, 28 and a threaded screw hole 36 is provided in the center of the fastener. There are two striker plates shown in FIG. 1. The upper plate 38 is intended for a deadbolt type lock and handle to be installed in opening 40 and edge bore 60 as indicated in FIG. 2. The bottom striker plate 42 is designed for the latch mechanism of a conventional spring biased latch and knob or handle to be installed in opening 24 and edge bore 61 as also indicated in FIG. 2.

Plates 38 and 42 have screw receiving holes 44 which are aligned with center holes 36 in the fastening clips 32. With the legs 34 positioned at the inside of the edges of slots 30 and the plates 38, 42 at the outer side of the edges of slot 30, screws 46 are inserted and tightened against the striker plates to secure the plates 38, 42 to the mullion 20. A spacer strip 27 fits between the plates 38, 42.

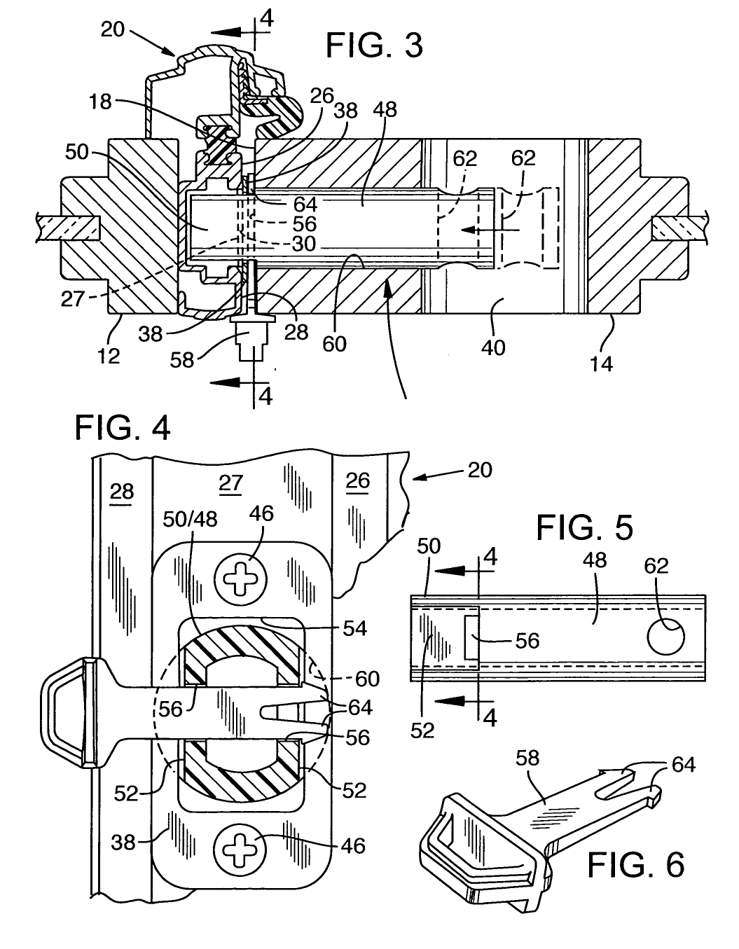

Reference is now made to FIGS. 3-6. FIG. 5 illustrates a plug portion 48 that is generally cylindrical in shape but has a protrudable end 50 that is provided with opposing flat sides 52. FIG. 4 shows this end portion 50 of plug 48 in cross section and as seated in striker plate opening 54, the opening being rectangular as noted which is accommodated by the flats 52. FIG. 6 shows in perspective view a type of keeper 58, the function of which will be explained further in the operational section which follows. The keeper is sized for insertion into and through a slot 56 (see FIG. 5) that is located at the inner end of the protrudable end portion 50 of plug 48. FIG. 4 illustrates the keeper 58 inserted into the slot 56.

FIG. 3 illustrates the retainer of this herein described preferred embodiment shown in solid line position (locked position) where the protrudable end portion 50 is protruded out of the bore 60 provided in the end 18 of the door (shown as dash or hidden lines in FIG. 1). The dash line position of the plug 48 shows the plug fully retracted into the bore 60 and out of engagement with the striker plate opening (unlocked position). In this latter position, the keeper 58 is necessarily withdrawn from the slot 56 of the plug 48. Movement of the plug 48 back and forth between lock and unlocked position is enabled by through bore 62 in plug 48. Any type of elongated pin or rod of a size that will fit the through bore 62 can be used to slide the plug 48 back and forth.

In operation, and as part of the assembly of the window portion 12 and door portion 14 to the frame 22, the assembler assembles the striker plates 38 and 42 to the mullion 20 as illustrated in FIG. 1. Because the slots 30 are oversized and not usable as a plug end receiver and also to obviate the need for an onsite installer to have to deal with securing the clip fasteners 32 and striker plates 38, 42 at the proper locations in the slot 30, the striker plates 38, 42 are installed at the factory site as previously explained. The assembler then opens the door 14 and inserts the plug 48 into bore 60 from the end edge 18. The protrudable end portion 50 is placed with its extreme end flush with the door edge 18. This places the inner end and opening 62 of the inner end in the circular opening 24, i.e., the dash line position of FIG. 3. The opening 62 is aligned for insertion of a rod or pin through the circular opening 40 and through opening 62 of the plug, and such properly positions the flats 52 and slot 56.

Using the rod or pin that is inserted into opening 62, the door 14 is closed, and the plug 48 is then slid outwardly through the bore 60 to extend the protrudable end 50 out of the bore 60 and into the rectangular opening 54 of striker plate 38. Upon location of the plug in the proper locked position, the slot 56 is exposed between the door 18 and striker plate 38 to permit insertion of keeper 58. The end of the keeper is formed into spring-like fingers 64 that will squeeze together to fit through the width of slot 56 and when fully seated, as seen in FIG. 4, removal is resisted but not prevented. Thus, the keeper will not likely fall out during handling and shipping but can be forcibly removed, the fingers 64 collapsing together, and the keeper thereby removable upon use of sufficient force.

The invention as described is directed to a preferred embodiment only and it is recognized that others in the art will conceive of numerous modifications and variations but without departing from the scope of the invention as intended by the normal meaning of the terms used to define the invention in the claims appended hereto. It will be obvious that whereas the retainer is illustrated for securement at the deadbolt position of opening 40, the same conditions exist for the spring biased prep opening 24 and edge bore 61. In the latter case, the retainer 48 would be inserted into opening 66 of striker plate 42.

1. A prehung patio door and retainer for retaining closure of the door during shipment from a factory site to a building site comprising:
a combination side by side window portion and pivotal door portion, a frame surrounding said combination, and a metal mullion located between said portions, said pivotal door portion pivotal between closed and opened positions and in the closed position in alignment with said frame with a distal door edge in proximal adjacency to an edge of said mullion;
said door portion prepped to receive a door latch mechanism and as prepped, including an edge bore extended into the door portion from said distal door edge, an elongate slot in said edge of said mullion defining opposed elongate edges, and locking clips secured to said elongate edges, a striker plate having a door latch opening, said locking clips cooperatively designed and positioned in said elongate slot securing the striker plate at a position to receive a door latch when installed in said edge bore of said door portion; and
a retainer plug configured to slidably fit the edge bore, a protrudable end portion of said retainer plug configured to fit said door latch opening of said striker plate whereby said retainer plug can be inserted into the bore of said door edge with the door in an open position and with the protrudable end portion substantially received in said bore to permit pivoting of the door to its closed position and which thereafter permits slidable protrusion of said protrudable end portion into the latch opening of said striker plate.

2. A prehung patio door and retainer as defined in claim 1 wherein a keeper slot is provided in said plug and positioned between the mullion and door edge with the end portion extended into the latch opening, and a keeper inserted into said keeper slot to resist return sliding of the plug in the edge bore.

3. A prehung patio door and retainer as defined in claim 2 wherein a cross bore is provided in the door for mounting a door handle of said latch mechanism, said plug exposed in part through said cross bore to permit gripping and manual sliding of said plug within said edge bore.

4. A prehung patio door and retainer as defined in claim 3 wherein said keeper includes resilient projecting fingers that are squeezed together when inserted in the slot of the plug to resist but permit retraction of the keeper from the slot of the plug upon assembly of said door to a building wall.
